(19) United States
(12) Patent Application Publication
(10) Pub. No.: US 2009/0029199 A1
(43) Pub. Date: Jan. 29, 2009

(54) Cathode Arrangements for Fuel Cells and Other Applications

(75) Inventor: Tao T. Tao, Hopkinton, MA (US)

Correspondence Address: WOLF GREENFIELD & SACKS, P.C., 600 ATLANTIC AVENUE, BOSTON, MA, 02210-2206, US

(73) Assignee: CellTech Power LLC, Westborough, MA (US)

(21) Appl. No.: 12/114,684

(22) Filed: May 2, 2008

Related U.S. Application Data
(60) Provisional application No. 60/927,435, filed on May 2, 2007.

(51) Int. Cl. H01M 4/64

(52) U.S. Cl. 429/13; 429/12

(57) ABSTRACT

The present invention generally relates to electrochemical devices such as fuel cells and, in particular, to cathode assemblies for use in such devices. In some aspects of the invention, the cathode assembly contains one or more channels able to transport a gas, such as air. In some cases, the channels may be defined by a cathode current collector and a cathode surrounding the cathode current collector, where the cathode current collector and the cathode define one or more channels. In some embodiments, the cathode contacts the current collector via one or more projections such that the cathode and the current collector are not in intimate contact. The cathode and the current collector, for example, may be in direct contact, and together define one or more spaces or conduits for gas flow. Other aspects of the invention relate to kits involving such cathode assemblies, methods of promoting the making or use of such cathode assemblies, and the like.

### RELATED APPLICATIONS

This application claims priority to U.S. Provisional Patent Application Ser. No. 60/927,435, filed May 2, 2007, entitled “Cathode Arrangements for Fuel Cells and other Applications,” which is incorporated herein by reference.

### FIELD OF INVENTION

The present invention generally relates to electrochemical devices such as fuel cells and, in particular, to cathode assemblies for use in such devices.

### BACKGROUND

The conversion of fuel to energy defines technology at the center of one of the most important industries in existence. Most energy conversion in this arena involves the combustion of fuel to produce mechanical, thermal, and/or electrical energy. Coal, oil, and gasoline are common fuels typically used in conventional combustion technology. The combustion of these common fuels (burning) involves applying enough heat to the fuel, in the presence of an oxidant such as the oxygen in air, for the fuel to undergo a relatively spontaneous and ill-defined combustive, often explosive, reaction in which chemical bonds in the fuel break and reactions with oxygen occur to produce new compounds that are released into the environment (exhaust). In the process, energy is released in the form of heat and an expansive force, which can be used to drive a piston, turbine, or other mechanical device. This mechanical energy can be used directly, e.g., to drive an automobile or propel a jet aircraft. It also can be converted into electrical energy by linking the mechanical device to an electrical generator. Or it can simply be used to provide heat, e.g., in a home.

Fuel combustion is, as noted, relatively ill-defined. That is, the precise chemistry occurring during combustion is not well known or easily controlled. What is known is that the resulting exhaust typically includes a wide variety of toxic compounds such sulfur-containing toxins, nitrous compounds, and unburned fuel droplets or particles (soot), some of which can be converted by sunlight into other toxins such as ozone, as well as a significant amount of carbon dioxide which, while not toxic, is an important greenhouse gas that many experts believe is affecting the environment.

Cutting edge research and development in the area of energy conversion is generally aimed at improving efficiency and/or reducing the emission of toxic pollutants and greenhouse gases. Fuel cells represent a significant advance in this area. Fuel cells are generally very clean and efficient, and also are very quiet, unlike most combustion engines and turbines. Fuel cells convert fuel directly into electrical energy via a relatively well-defined, controllable, electrochemical reaction that does not involve explosive combustion. In some systems, the only reaction product exhausted into the environment is water. In electrical production, no intermediate mechanical device, such as a piston engine or turbine, is needed; thus, the process is generally much more efficient, since intermediate mechanical devices cause significant energy loss through friction, etc. The efficiency of conversion of fuel to mechanical energy via combustion in a piston engine is also hampered by the laws of physics; the Carnot Cycle, via which piston engines operate, determine the limit of efficiency in the conversion of heat, from combustion, into mechanical work. Significant loss of energy is unavoidable.

While fuel cell technology has been developed to some extent, it has not assumed a significant role in worldwide energy conversion. One example of a fuel cell is the tubular solid oxide fuel cell developed by a number of developers including Westinghouse; this design is hampered by large cathode circumferential electrical resistances, which results in lower efficiency. Significant improvements in fuel cell technology are likely needed to advance fuel cell usage.

### SUMMARY OF THE INVENTION

The present invention generally relates to electrochemical devices such as fuel cells and, in particular, to cathode assemblies for use in such devices. The subject matter of the present invention involves, in some cases, interrelated products, alternative solutions to a particular problem, and/or a plurality of different uses of one or more systems and/or articles.

In one aspect, the present invention is directed to a cathode assembly for an electrochemical device. In one set of embodiments, the assembly comprises a current collector comprising a core comprising a metal and a ceramic shell surrounding at least a portion of the core, and a cathode in electrical contact with the current collector. In some cases, the current collector and cathode are constructed to define one or more channels for flow of an oxidant gas through the cathode assembly, and in certain instances, the cathode contacts the current collector via one or more projections integrally formed with the cathode. The assembly, according to another set of embodiments, includes a current collector, and a cathode in electrical contact with the current collector. In some cases, the current collector and cathode are constructed to define one or more channels for flow of a gas. In yet another set of embodiments, the assembly includes a current collector, and a cathode in electrical contact with the current collector. In some cases, the cathode contacts the current collector via one or more projections such that the cathode and the current collector are not in intimate contact. In one aspect, the invention is directed to a cathode assembly containing therein one or more channels able to transport a gas.

The invention is directed to a method in another aspect. In a first set of embodiments, the method includes an act of operating an electrochemical device comprising an electrode assembly comprising a first electrode, a current collector in electrical communication with the first electrode, an electrolyte, a second electrode, and an electrical circuit establishing electrical and/or electrochemical communication between the first electrode, the current collector, the second electrode, and the electrolyte, and while operating the electrochemical device, flowing a gas through a channel defined at least in part by the first electrode and the current collector.

In another aspect, the present invention is directed to a method of making one or more of the embodiments described herein, for example, a cathode assembly for a fuel cell. In another aspect, the present invention is directed to a method of using one or more of the embodiments described herein, for example, a cathode assembly for a fuel cell.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates one embodiment of the invention, showing a cathode assembly containing an even number of channels;

FIG. 2 illustrates another embodiment of the invention, showing a cathode assembly containing an odd number of channels;

FIG. 3 illustrates yet another embodiment of the invention, showing a square cathode assembly;

FIG. 4 illustrates still another embodiment of the invention, showing a non-circular cathode assembly;

FIG. 5 illustrates yet another embodiment of the invention, showing an off-center current collector in a cathode assembly;

FIG. 6 illustrates another embodiment of the invention, showing a cathode assembly containing more than one current collector;

FIG. 7 illustrates still another embodiment of the invention, showing a square current collector contained within a circular cathode; and

FIG. 8 is an illustration of a general arrangement of a chemical or fuel-rechargeable energy conversion unit, in certain embodiments of the invention.

### DETAILED DESCRIPTION

The present invention generally relates to electrochemical devices such as fuel cells and, in particular, to cathode assemblies for use in such devices. In some aspects of the invention, the cathode assembly contains one or more channels able to transport a gas, such as air. In some cases, the channels may be defined by a current collector and a cathode surrounding the current collector, where the current collector and the cathode define one or more channels. In some embodiments, the cathode contacts the current collector via one or more projections such that the cathode and the current collector are not in intimate contact. Other aspects of the invention relate to kits involving such cathode assemblies, methods of promoting the making or use of such cathode assemblies, and the like.

The following are incorporated herein by reference: a U.S. provisional patent application filed on May 2, 2007, entitled “Porous Ceramic Materials,” by T. Tao, et al. (U.S. Patent Application Ser. No. 60/927,434); and a U.S. patent application filed on May 2, 2007, entitled “Electrochemical Device Configurations,” by T. Tao, et al. (U.S. patent application Ser. No. 11/800,050).

One aspect of the invention is generally directed to a cathode assembly, including a cathode and a current collector, containing one or more channels able to transport a fluid, for example, a gas (such as air or oxygen). In some cases, the channels may be defined by a current collector and a cathode surrounding the current collector, where the current collector and the cathode define one or more channels. In some embodiments, the cathode contacts the current collector via one or more ribs or projections, which may define at least a portion or wall of one or more of the channels.

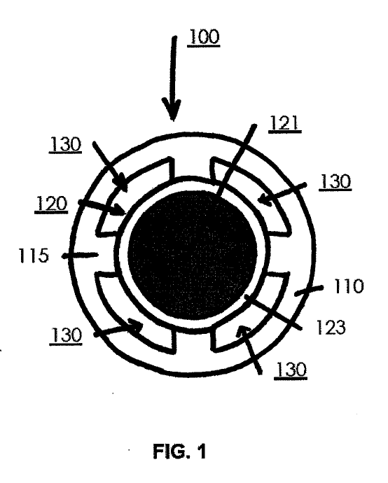

A non-limiting example of a cathode assembly of the invention is shown in FIG. 1. In this example, cathode assembly 100 is substantially cylindrical, and a cross-section of the cathode assembly is shown. Cathode assembly 100 includes a cathode 110, and a current collector 120. The current collector may be directly connected to (or otherwise be in electrical communication with) a lead, e.g., to conduct electricity. The current collector, as shown here, may include core 121 and sheathing material 123 surrounding at least a portion of core 121. Core 121 may comprise a metal, for instance, copper, nickel, a mix or alloy, or a noble metal such as silver, platinum, or gold. Sheathing material 123, when present, may be a ceramic, for example, LSC (a lanthanum-strontium-chromium oxide). However, sheathing material 123 is not required to be present, e.g., for noble metals. Additional materials and configurations are discussed below.

Around current collector 120 is cathode 110. However, cathode 110 and current collector 120 are not in direct or intimate contact, and there are spaces or partitions between these elements within cathode assembly 100. In this example, these spaces or partitions are created by projections or “ribs” 115, extending inwardly from cathode 110 and coming into contact with sheathing material 123. Current from the cathode can reach the current collector via these. The projections or ribs may be created, for example, as part of the cathode, for instance, in an extrusion process, using an appropriately shaped die, during the formation of the cathode. Thus, in some cases, the rib or projection may be formed of the same material as the cathode. In other cases, however, the ribs or projections may be added after formation of the cathode. It should be noted that, in this example, the ribs or projections appear as short segments in cross-section, but can be extended along the length of cathode assembly 100 in some cases (e.g., into or out of the page), and thus, in some embodiments, the ribs or projections may define one or more walls of the channels. Thus, the spaces or partitions shown in FIG. 1 (identified as spaces 130) may actually be channels passing along the length of cathode assembly 100. However, in other embodiments, isolated ribs or projections (i.e., which do not define walls of channels) may be used, as well as combinations of these.

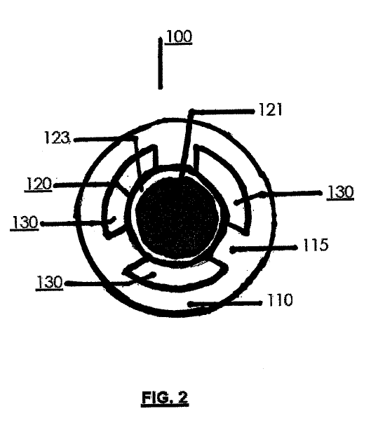

Any number of such channels can be created, depending on the application. For example, in FIG. 1, four such channels are formed in cross section, although one or more of these may be in fluidic communication. For example, two of the channels may allow flow of materials (oxygen, air, etc.) into the plane of the page, while the other channels may allow flow of the materials out of the page (e.g., waste products, cathode exhaust, etc.). In addition, it should be noted that the number of channels need not be even, although they can be, as even numbers of channels may allow for substantially equal flowrates of fluid into and out of the device. For example, if air is used as an oxidant in a cathode, fresh air and reacted (“spent”) air may have no, or only nominal, volumetric changes. However, in other embodiments, substantial changes of volume may occur (for example, for oxygen or enriched air, e.g., enriched in oxygen), and the volumetric rates of flow into and out of the cathode may be different (for instance, the shape and/or numbers of channels may be different; for example, there may be more channels that allow inflow than outflow). A cathode assembly with an odd number of channels is shown in FIG. 2. Also, it should be noted that in FIG. 2, ribs or projections 115 can be formed from sheathing material 123 and/or core material 121 (e.g., if no sheathing material 123 is present), rather than from the cathode material. In still other embodiments (not shown), both sheathing material and cathode material may be used to form the projections, and in yet other embodiments, other materials may be used to form ribs or projections. In still other embodiments, a combination of ribs and/or projections may be used, and in yet other cases, as discussed below, no projections or ribs are used.

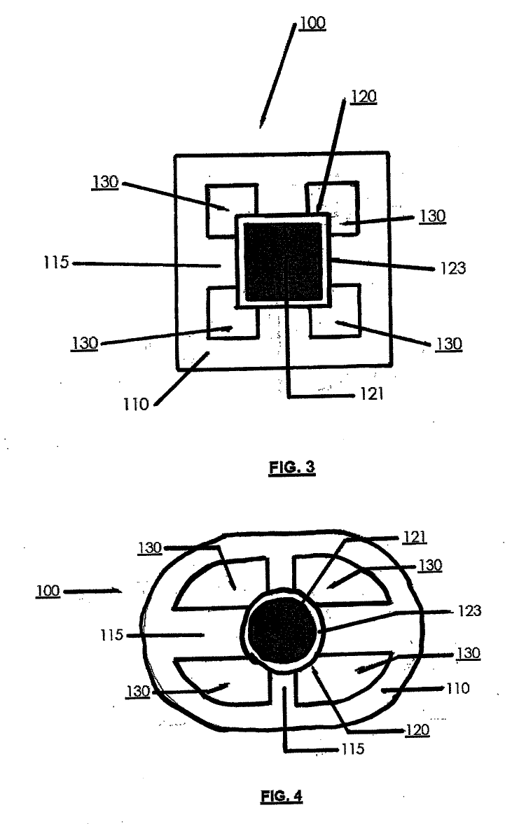

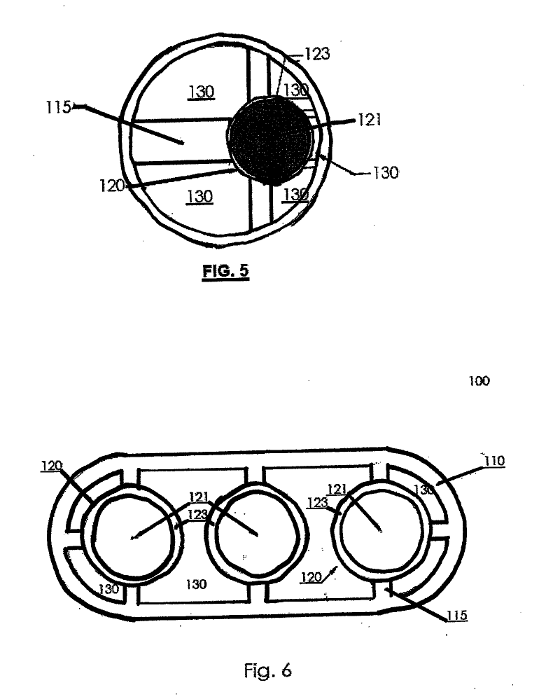

It should also be noted that the cathode assembly need not be circular in cross-section. For instance, FIG. 3 shows a cathode assembly having a square cross-section, and in FIG. 4, a cathode assembly having a generally oblong cross-section is shown. Other shapes are also possible, e.g., triangular, pentagonal, hexagonal, irregular, elliptical, sawtoothed, waved, rimed, etc. It should also be noted that, although these figures illustrate cathode assemblies where the current collector is positioned in the center of the cathode, in other embodiments of the invention, the current collector need not be. For instance, in FIG. 5, a current collector 120 is shown positioned off-center with respect to cathode 110. In addition, in some cases, more than one current collector may be present. As an example, FIG. 6 illustrates a cathode assembly having three current collectors and one cathode surrounding each of the current collectors.

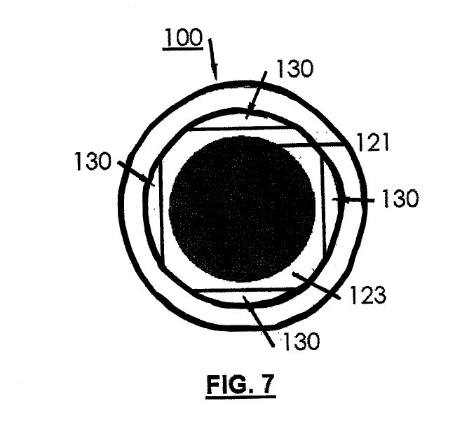

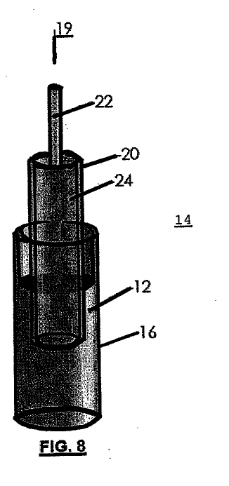

As mentioned above, ribs and projections are not necessarily required. For example, in FIG. 7, cathode 110 has a generally circular shape, but current collector 120, including core 121 and sheathing material 123, has a square shape. Naturally, theses two shapes cannot be positioned in direct or intimate contact, and various spaces or channels 130 may be created as a result.

Accordingly, in one set of embodiments, the cathode assembly may include a current collector and a cathode. The current collector can be selected to adequately deliver or remove electrical current to or from a cathode and/or other like components, to operate effectively at typical device temperatures, and/or to be adequately resistant to conditions within the device that can cause chemical degradation to non-resistant materials. Non-limiting examples include silver, gold, and/or platinum as a cathode current collector. Other non-limiting examples are discussed below. A wide variety of useful current collectors are described in International Patent Application No. PCT/US03/03642, filed Feb. 6, 2003, entitled “Current Collectors,” by T. Tao, et al., published as WO 03/067683 on Aug. 14, 2003, incorporated herein by reference.

In one arrangement, a current collector includes a sheathing material, a core, and an electrical lead in contact with the core. The sheathing material may define a shell surrounding at least a portion of the core. The core may be, for example a metal, for example, copper, nickel, steel, or a noble metal. Other non-limiting examples of metals useful in cathodes include any one or more than one of platinum, palladium, gold, silver, copper, rhodium, rhenium, iridium, osmium, and combinations thereof. As another example, a core may comprise a liquid metal (metal or alloy that is a liquid under typical operating conditions within an interior space of the sheathing material, and an electrical lead in contact with the liquid metal. Liquid metals can be selected from among, for example, copper, molybdenum, iridium, palladium, antimony, rhenium, bismuth, platinum, silver, arsenic, rhodium, tellurium, selenium, osmium, gold, lead, germanium, tin, indium, thallium, cadmium, nickel, iron, cobalt, zinc, and/or alloys thereof.

Examples of sheathing material include, but are not limited to, electrically conducting ceramics such as oxides of scandium, indium, a lanthanide, yttrium, titanium, tin, indium, aluminum, zirconium, iron, cobalt, manganese, strontium, calcium, magnesium, barium, beryllium, a lanthanide, chromium, and mixtures thereof, such as an LSC or an LCC. As used herein, “LCC” refers to any lanthanum-calcium-chromium oxide. Other, non-limiting examples of sheathing materials include ceramics made of W—C, Si—C, Si—N, etc.

Combinations of any of the above compounds are also possible (for the core and/or the sheathing material), such as alloys of any of the above metals, which may include combinations of the above metals or combinations with other metals as well. One example is a platinum-silver alloy having any suitable ratio, for example, 5% Pt:95% Ag, 10% Pt:90% Ag, 20% Pt:80% Ag, or the like.

In some embodiments, the electrically conducting material and/or the sheathing material may be a heterogeneous material formed from a mixture of materials. The mixture may be a mixture including any one of the materials previously described, for example, a ceramic mixture, a metal mixture, or a cermet mixture, where a “cermet” is a mixture of at least one metal compound and at least one ceramic compound, for example, as previously described. As one example, the cermet may include a material such as copper, silver, platinum, gold, nickel, iron, cobalt, tin, and/or indium, and a ceramic such as zirconium oxide, an aluminum oxide, an iron oxide, a nickel oxide, a lanthanum oxide, a calcium oxide, a chromium oxide, a silicate, and/or a glass. Combinations of any of these materials are also contemplated. Additionally, other materials may be incorporated in the cermet, for example, graphite. Suitable cermet mixtures may include, for example, Cu/YSZ, NiO/NiFe₂O₄, NiO/Fe₂O₃/Cu, Ni/YSZ, Fe/YSZ, Ni/LCC, Cu/YSZ, NiAl₂O₃, or Cu/Al₂O₃. A “YSZ,” as used herein, refers to any yttria-stabilized zirconia material, for example, (ZrO₂)(HfO₂)_{0.02}(Y₂O₃)_{0.08}.

The cathode may be solid state, for example, a ceramic, a metal oxide, and/or a mixed metal oxide. Specific, non-limiting examples include tin-doped In₂O₃, aluminum-doped zinc oxide, zirconium-doped zinc oxide, lanthanum-calcium-manganese oxide, or lanthanum-strontium-manganese oxide.

A specific example of a solid state cathode is a perovskite-type oxide having a general structure of ABO₃, where “A” and “B” represent two cation sites in a cubic crystal lattice. A specific example of a perovskite-type oxide has a structure LaₓMn_{y}AₐB_{b}C_{c}O_{d} where A is an alkaline earth metal, B is selected from the group consisting of scandium, yttrium and a lanthanide metal, C is selected from the group consisting of titanium, vanadium, chromium, iron, cobalt, nickel, copper, zinc, zirconium, hafnium, aluminum and antimony, x is from 0 to about 1.05, y is from 0 to about 1, a is from 0 to about 0.5, b is from 0 to about 0.5, c is from 0 to about 0.5 and d is between about 1 and about 5, and at least one of x, y, a, b and c is greater than zero.

More specific examples of perovskite-type oxides include, but are not limited to, LaMnO₃, La_{0.84}Sr_{0.16}MnO₃, La_{0.84}Ca_{0.16}MnO₃, La_{0.84}Ba_{0.16}MnO₃, La_{0.65}Sr_{0.35}Mn_{0.8}CO_{0.2}O₃, La_{0.79}Sr_{0.16}Mn_{0.85}CO_{0.15}O₃, La_{0.84}Sr_{0.16}Mn_{0.8}Ni_{0.2}O₃, La_{0.84}Sr_{0.16}Mn_{0.8}Fe_{0.2}O₃, La_{0.84}Sr_{0.6}Mn_{0.8}Ce_{0.2}O₃, La_{0.84}Sr_{0.16}Mn_{0.8}Mg_{0.2}O₃, La_{0.84}Sr_{0.16}Mn_{0.8}Cr_{0.2}O₃, La_{0.6}Sr_{0.35}Mn_{0.8}Al_{0.2}O₃, La_{0.84}Sc_{0.6}MnO₃, La_{0.84}Y_{0.16}MnO₃, La_{0.7}Sr_{0.3}Co_{0.3}, LaCo_{0.3}, La_{0.7}Sr_{0.3}FeO₃, La_{0.5}Sr_{0.5}CO_{0.8}Fe_{0.2}O₃, La_{0.84}Sr_{0.16}MnO₃, or other LSM materials. As used herein, “LSM” refers to any lanthanum-strontium-manganese oxide, such as La_{0.84}Sr_{0.16}MnO₃.

In other embodiments, the ceramic may also include other elements, such as titanium, tin, indium, aluminum, zirconium, iron, cobalt, manganese, strontium, calcium, magnesium, barium, and/or beryllium. Other examples of solid state cathodes include LnCoO₃, LnFeO₃, LnCrO₃, and a LnMnO₃-based perovskite oxide cathode, such as Ln_{0.75}Sr_{0.25}CrO₃, (Ln_{0.6}Sr_{0.4})_{0.9}CrO₃, Ln_{0.6}Sr_{0.4}FeO₃, Ln_{0.6}Sr_{0.4}CoO₃, or Ln_{0.6}Sr_{0.4}CoO₃, where Ln may be any one of La, Pr, Nd, Sm, or Gd. Alternatively, the cathode may comprise a metal, for example, the cathode may comprise a noble metal. Examples of metals useful in cathodes include any one or more than one of platinum, palladium, gold, silver, copper, rhodium, rhenium, iridium, osmium, and combinations thereof.

The cathode, optionally including any associated current collector, may be constructed to define one or more channels for flow of a gas through the cathode assembly. For example, the cathode and/or the current collector may each contain channels through which a gas may flow, or there may be a “gap” between the cathode and the current collector, which defines a channel for a gas. Non-limiting examples of such cathodes have been described above with respect to the figures.

In one set of embodiments, the cathode and/or the current collector may contain one or more projections or ribs that cause a gap to form when the cathode and the current collector are assembled together in the cathode assembly. Thus, the cathode and current collector cannot be intimately contacted together, even though the cathode and the current collector may be in direct physical contact, i.e., the cathode and the current collector cannot be put into intimate contact such that there is no space between them. In some embodiments, the projections or ribs may be integrally formed with the cathode and/or with the current collector; in other embodiments, however, the projections or ribs are not integrally formed, but are added during the assembly process. In some cases, the projections or ribs may define walls of the channels.

There may be any number of channels formed within the cathode assembly. In some cases, there may be an even number of channels, e.g., such that the gas flows into the cathode assembly and out of the cathode assembly may be substantially equal. However, in other cases, there may be an odd number of channels within the cathode assembly. As an example, in oxygen enriched air or pure oxygen, the number of inlet channels may be greater than the outlet channels, e.g., to compensate for larger volume (flow rate) reduction.

Additionally, the cathode (including any associated current collector) may be positioned in the center of an electrolyte (discussed in detail below), in some embodiments of the invention. For instance, the geometrical center of the electrolyte may be contained within the cathode (e.g., within a channel in the cathode, within a current collector, etc.).

The cathode assemblies disclosed herein can be used in any suitable fuel cell. One example of a fuel cell follows, but this should not be seen as limiting. It is to be understood that the specific electrochemical devices described herein are exemplary only, and the components, connections, and techniques of the present invention can be applied to virtually any suitable electrochemical device including those with a variety of solid, liquid, or gaseous fuels, and a variety of anodes, and electrolytes, all of which can be liquid or solid under operating conditions (where feasible; generally, for adjacent components one will be solid and one will be liquid if any are liquids). It is also to be understood that the cathode assemblies shown in the figures are merely examples of electrochemical devices that can make use of systems and techniques of the present invention as recited herein, and that, in other embodiments, other cathode assemblies or even anode assemblies using similar structures may be prepared in accordance with the systems and techniques discussed herein. Many structural arrangements other than those disclosed herein, which make use of and are enabled by the present invention, will be apparent to those of ordinary skill in the art, and some are disclosed herein.

A variety of electrochemical devices can benefit from the present invention. Wherever “fuel cell” is used in any of the references incorporated herein, it is to be understood that any electrochemical device, including all disclosed herein, can be substituted.

The present invention provides, in some embodiments, structures and arrangements for facilitating an electrochemical reaction at an electrode of an electrochemical device, with particular use in fuel cells and other fuel-to-energy conversion devices, in some cases, in the absence of additional fuel reforming or processing. However, the electrode assemblies of the present invention also find use in a variety of other fuel cells or other fuel-to-energy conversion devices besides the examples discussed below. Those of ordinary skill in the art will have knowledge of such devices.

A fuel-to-energy conversion device is a device that converts fuel to electrical energy electrochemically, that is, without combustion of the fuel (although a fuel-to-energy conversion devices could be used in conjunction with a device deriving energy from combustion of the same fuel; most fuel cells do not). A typical, conventional fuel cell includes two electrodes, an anode and a cathode, an electrolyte in contact with both the anode and cathode, and an electrical circuit connecting the anode and the cathode from which power created by the device is drawn. In typical operation, an oxidant (e.g., oxygen, or simply air) is provided to the cathode where it is chemically reduced, e.g., to oxygen ions, which are delivered to the anode via the electrolyte. Fuel, such as hydrogen, a hydrocarbon, and/or a carbonaceous fuel (or other fuels, e.g., described herein), is supplied to the anode where it reacts with the oxygen ions to form water and/or carbon dioxide, and the reaction releases electrons as the fuel is oxidized. The electrons are removed from the anode by a current collector, or other component of an electrical circuit. The overall reaction is energetically favorable, i.e., the reaction gives up energy in the form of energetic or power driving electrons from the anode, through electrical circuitry, to the cathode. This energy can be captured for essentially any purpose.

Some embodiments of the present invention also can act as a rechargeable energy conversion unit, using fuel to produce energy which can be immediately discharged for use, can be stored for later discharge, or the like. In an energy conversion storage process, fuel can be supplied to an anode and reacted with oxides as the fuel is oxidized, as described above, with energy being stored in the unit. In one embodiment, energy can be stored in the anode, in this process, as the oxidation of fuel drives a metal/metal oxide species equilibrium within the anode toward the metal (metal oxide is reduced to metal). This stored energy can be discharged by allowing this equilibrium to move toward the metal oxide species (with metal or metal oxide reacting with oxygen ion, described above, to generate metal oxide or a more oxidized metal oxide species, respectively). In some embodiments of the invention, the storage of energy can take other forms; in case of carbon rich fuels, soot deposition in the anode fuel chamber often occurs. Pre-charged carbon in the anode fuel chamber and/or soot formed during operation may react in situ with water or carbon dioxide, which may further release hydrogen and/or carbon monoxide, both being usable as fuel. In this arrangement, fuel-to-energy conversion can result in energy, all of which (with the exception of that lost to thermodynamic inefficiency) can be stored in the device, all of which can be discharged for use simultaneous with conversion, or the device can operate with the level of energy conversion during fuel consumption at a level varying independently with the amount of energy discharged by the device. For example, where more energy can be converted from fuel in the device than is discharged by the device, storage can occur, and where more discharge by the device is required than the amount of energy that can be converted from fuel, the energy mismatch can be made up by drawing upon stored energy within the device. Any or all of these processes can happen simultaneously or independently of each other. In some embodiments, the present invention provides structures and arrangements for linking a plurality of electrochemical devices such that they can operate together, and related methods and techniques.

Individual aspects of the overall electrochemistry and/or chemistry involved in electrochemical devices such as those described herein is generally known, and will not be described in detail herein. The reader can refer to the patent applications and publications incorporated herein by reference for a detailed description of some of the specific electrochemistry involved in various devices that can find use in connection with the present invention.

One aspect of the invention is generally directed to a fuel cell (or other electrochemical device) containing an anode surrounding an electrolyte and/or a cathode. The anode may be fluid during operation, and contained within a separator, which can be exposed to a fuel surrounding the separator. In some cases, as discussed below, the separator may be a ceramic, and in some embodiments, the separator is porous.

Referring now to FIG. 8, a schematic illustration of one general geometric arrangement of an electrochemical device is shown. As used herein, a “chemical or fuel-rechargeable energy conversion unit” is a unit which has the ability to electrochemically convert a fuel (a chemical) to energy, and to store at least a portion of that energy for later discharge, with or without additional fuel processing or reforming in case of common fuels are used. In one embodiment, the unit can convert fuel to energy and store essentially all of that energy (all of the energy not lost to thermodynamic inefficiencies), for later discharge. In another embodiment, some of the converted energy is discharged (used to provide power to a home, auto, business, etc.) essentially immediately upon conversion, while some is stored for discharge later, e.g. when fuel is not available and/or when power demands exceed the ability of the device to convert fuel to energy.

In FIG. 8, electrochemical device 10 is arranged in a substantially cylindrical configuration including outer container 16 (which may be, e.g., a porous separator, as discussed below), containing anode 12, a substantial portion of which may become fluid during operation of electrochemical device 10. Within anode 12 is a cylindrical electrolyte 20, immersed within at least a portion of anode 12, and cathode 24, contained within electrolyte 20. Within cathode 24 is conduit 22, positioned to deliver air (or another oxidant) in or out of cathode 24. Cathode 24 may contain a cathode current collector, and in some cases, the positioning of the cathode and the cathode current collector may define one or more conduits (e.g., conduit 22) through which a gas can flow. Examples of cathode and cathode current collector arrangements have been discussed above and with respect to FIGS. 1-7. Typically, as discussed below, fuel 14 outside of the electrochemical device 10 may be transported across outer container 16 to reach anode 12. For instance, outer container 16 may be porous, as discussed below. In some cases, cathode 24 may include one or more current collectors, and the current collector(s) and cathode may be constructed and arranged to define conduit 22. For example, projections or ribs on the cathode and/or the cathode current collector may prevent the cathode and the cathode current collector from coming into intimate contact, thereby creating one or more spaces or conduits through which a fluid can flow.

A variety of modifications can be made to the arrangement of FIG. 8 to increase or decrease thickness of any component and/or change the relative surface area of contact between any two components in comparison to the surface area of contact between any other two components. For example, the “thickness” of anode 12 can be varied simply by varying the external diameter of outer container 16 and/or the internal diameter of electrolyte 20. As an example of relative surface area variation, the surface area of outer container 16 exposable to anode 12 can be decreased, relative to the surface area of electrolyte 20 exposed to anode 12, by decreasing the height of outer container 16 and/or decreasing its radius. The same can be decreased by decreasing the fluid level of anode 12 within outer container 16.

The ability to vary the thickness of the elements of an electrochemical device according to various embodiments of the invention and/or adjust the relative areas of surface contact between components of the device can impact the power output or the efficiency of the device. For example, portions of the system which are of relatively low conductivity, high diffusion resistance (polarization), or are otherwise rate limiting, may be decreased in thickness. Similarly, it is possible to reduce the amount of higher cost materials used. In particular, embodiments of the present invention allow a liquid anode to be contained by a porous separator, in turn allowing the anode to be kept relatively thin (e.g., significantly, proportionately thinner than as illustrated in FIG. 8). Reductions in anode thickness, in some embodiments, can reduce the diffusion (polarization) resistance of the electrochemical device, and reduces the amount of anode material required, improving power output and/or efficiency, and/or reducing cost and weight.

In typical use, an oxidant, such as air, is allowed to contact cathode 24, e.g., via structures such as those shown in FIGS. 1-7. Electrons delivered from an external circuit, described more fully below, may combine with oxygen molecules (or other oxidant) at cathode 24 to form oxygen ions, and deliver the oxygen ions across electrolyte 20 to anode 12. In one embodiment, anode 12 is a liquid anode comprising a metal and various oxidation products of the metal. In such an arrangement, the oxygen ions delivered by the electrolyte can oxidize anode metal atoms to form an oxidation product (which can be one of a variety of oxidation products including metal oxide, in various stoichiometries, optionally with other species) and releases electrons, forming an electric circuit. An oxygen containing species (e.g., dissolved oxygen or oxides) may diffuse within anode 12, reaching inner container 16, while fuel 14 can diffuse across outer container 16 to the inner surface to oxidize the fuel 14. In some cases fuel 14 (e.g., hydrogen) may dissolve slightly in anode 12, and/or partial fuel oxidation may occur within the anode 12. Fuel is delivered from a source that is not shown. In some arrangements, the anode exhaust can simply vent into air, but in many arrangements, the anode exhaust will be collected in an exhaust conduit and can be treated in an environmentally sound manner. The anode exhaust typically will contain water, unspent fuel (which can be re-used), and/or carbon dioxide.

It is to be understood that the specific electrochemical devices described herein are exemplary only, and the components, connections, and techniques of the present invention can be applied to virtually any suitable electrochemical device including those with a variety of solid, liquid, and/or gaseous fuels, and a variety of anodes, cathodes, and electrolytes, all of which can be liquid or solid under operating conditions (where feasible; generally, for adjacent components one will be solid and one will be liquid if any are liquids). It is also to be understood that the chemical or fuel-rechargeable energy conversion unit arrangement shown in the figures are merely examples of electrochemical devices that can make use of systems and techniques of the present invention as recited herein. Many structural arrangements other than those disclosed herein, which make use of and are enabled by the present invention, will be apparent to those of ordinary skill in the art, and some are disclosed herein.

The invention allows for modification of design that can be used to affect device power, battery storage capacity, and makes them suitable for converting common fuels directly into electricity without additional fuel reforming, in certain embodiments of the invention. For example, by increasing surface area of contact between the container positioned between the fuel and anode, continuous power output is improved. By increasing the amount of anode present, battery storage is increased, in embodiments where a rechargeable anode is used. Each of these can be controlled, independently of each other, e.g. by changing the radius of the container (where cylindrical), or designing the container in other ways to geometrically create more surface area (e.g. with a wavy, jagged, and/or a porous separator), and/or by increasing or decreasing the thickness of the anode. These changes can be useful when designing different fuel-to-energy conversion devices for different uses requiring more or less power and/or more or less battery storage capacity, e.g., for home power use, commercial or industrial use, automobile use, different climates, portable, mobile or stationary applications, etc.

Electrochemical devices of the present invention may take the form of any kind of electrochemical device including fuel cells, batteries, fuel-to-energy conversion devices such as chemical or fuel-rechargeable energy conversion units, dual function devices, electrochemical devices comprising chemically rechargeable anodes, and essentially any similar devices such as those disclosed in International Patent Application No. PCT/US01/12616, filed Apr. 18, 2001, entitled “An Electrochemical Device and Methods for Energy Conversion,” by T. Tao, et al., published as WO 01/80335 on Oct. 25, 2001, or U.S. patent application Ser. No. 11/167,079, filed Jun. 24, 2005, entitled “Components for Electrochemical Devices Including Multi-Unit Device Arrangements,” by A. Blake, et al., published as U.S. Patent Application Publication No. 2006/0040167 on Feb. 23, 2006, each incorporated herein by reference. As described above, electrochemical devices according to the present invention may also have a wide variety of geometries including cylindrical, planar, and other configurations.

An electrochemical device according to the present invention may be combined with additional electrochemical devices to form a larger device or system. In some embodiments this may take the form of a stack of units or devices, such as fuel cells. Where more than one electrochemical device is combined, the devices may all be devices according to the present invention, or one or more devices according to the present invention may be combined with other electrochemical devices, such as conventional solid oxide fuel cells. Fuel-to-energy conversion devices are provided as one non-limiting example of electrochemical devices which can be linked in accordance with the invention. It is to be understood that where this terminology is used, any suitable electrochemical device, which those of ordinary skill in the art would recognize could function in accordance with the systems and techniques of the present invention, can be substituted.

Various components of the invention, such as the anode, cathode, current collectors, electrolyte, separator, container, circuitry, etc. can be fabricated by those of ordinary skill in the art from any of a variety of components, as well as those described in any of those patent applications described herein. Components of the invention can be molded, machined, extruded, pressed, isopressed, infiltrated, coated, in green or fired states, or formed by any other suitable technique. Those of ordinary skill in the art are readily aware of techniques for forming components of devices herein. Specific examples of various components follow, but the invention is not to be considered limited to these.

The anode can be formed from any suitable material. As an example, the anode can be a rechargeable anode, such as is taught in International Patent Application No. PCT/US01/12616, filed Apr. 18, 2001, entitled “An Electrochemical Device and Methods for Energy Conversion,” by T. Tao, et al., published as WO 01/80335 on Oct. 25, 2001, incorporated herein by reference, and can be selected from among metal or metal alloy anodes that are capable of existing in more than two oxidation states or in non-integral oxidation states. Certain metals can be oxidized to one or more oxidation states, any one of these states being of a sufficient electrochemical potential to oxidize the fuel. Conversely, if that metal is oxidized to its highest oxidation state, it may be reduced to more than one lower oxidation state (i.e., at least one having a higher oxidation state than neutral) where the anode is capable of functioning in any of these states. Alternatively, a metal oxide or mixed metal oxide may collectively oxidize fuel where metal ions are reduced by formal non-integer values.

Where a metal anode is used, the anode can be a mixture or an alloy of different metals in some cases (e.g., if the different metals are in the solid state). In such an arrangement, metal atoms in the anode can cycle between two or more oxidation states including metal and various species of metal oxide. The overall reaction described is energetically favorable, thus power can be drawn from an electrical circuit connecting the anode with the cathode.

Examples of anodic material that can be used to form the anode, or compounded with other materials to define an anode, include fluid anodes such as liquid anodes (that is, a material that is a liquid at operating temperatures of the device). In one embodiment, the device is operable, with the anode in a liquid state, at a temperature of less than about 1500° C., less than about 1300° C., less than about 1200° C., less than about 1000° C., or less than about 800° C. By “operable,” it is meant that the device is able to generate electricity, either as an electrochemical device such as a fuel-to-energy conversion device, a fuel cell, or as a rechargeable device such as a battery and/or a chemical or fuel-rechargeable energy conversion unit with the anode in a liquid state, and the anode may not necessarily be a liquid at room temperature. It is understood by those of ordinary skill in the art that anodic temperature can be controlled by selection of anode materials or in the case of a mixture of metals, molten salts, and/or molten oxides, composition and percentages of the respective components, i.e., composition can affect the melting point of the anode. Other non-limiting exemplary operating temperature ranges include a temperature between about 300° C. to about 1500° C., between about 500° C. to about 1300° C., between about 500° C. to about 1200° C., between about 500° C. to about 1000° C., between about 600° C. to about 1000° C., between about 700° C. to about 1000° C., between about 800° C. to about 1000° C., between about 500° C. to about 900° C., between about 500° C. to about 800° C., between about 600° C. to about 800° C., etc.

In some embodiments, the anode can be a pure liquid or can have solid and liquid components, so long as the anode as a whole exhibits liquid- or fluid-like properties. In some cases, the anode can have the consistency of a paste or a highly viscous fluid. Where the anode is a metal, it can consist essentially of a pure metal or can comprise an alloy comprising two or more metals. In one set of embodiments, the anodic material is selected so as to have a standard reduction potential greater than −0.70 V versus the Standard Hydrogen Electrode (determined at room temperature). These values can be obtained from standard reference materials, or measured by using methods known to those of ordinary skill in the art. The anode can comprise any one or more than one of a transition metal, a main group metal, and combinations thereof. Metals such as copper, molybdenum, mercury, iridium, palladium, antimony, rhenium, bismuth, platinum, silver, arsenic, rhodium, tellurium, selenium, osmium, gold, lead, germanium, tin, indium, thallium, cadmium, gadolinium, chromium nickel, iron, tungsten, cobalt, zinc, vanadium, or combinations thereof, can also be useful. Examples of alloys include, but are not limited to, 5% lead with reminder antimony, 5% platinum with reminder antimony, 5% copper with reminder indium, 20% lead, 10% silver, 40% indium, 5% copper. In another set of embodiments, the liquid anode of the electrochemical device may include a molten salt, such as carbonates, sulfates, chlorides, fluorides, phosphates and nitrates, and/or a molten oxide, such as antimony oxide, and/or combinations thereof.

Although liquid anodes are more commonly used in the invention (e.g., liquid metal, molten salt, molten oxides, etc.), solid anodes can be used as well, including metals such as main group metals, transition metals such as nickel, lanthanides, actinides, ceramics (optionally doped with any metal listed herein). Indeed, any suitable anode may be used with the present invention. Other suitable solid anodes are disclosed in references incorporated herein.

The fuel supplied to the device may be delivered in any manner that provides sufficient fuel to the needed locations. The nature of the fuel delivery may vary with the type of fuel. For example, solid, liquid, and gaseous fuels may all be introduced in different manners. A variety of fuel delivery options useful with liquid anodes are disclosed in International Patent Application No. PCT/US02/37290, filed Nov. 20, 2002, entitled “An Electrochemical System and Methods for Control Thereof,” by T. Tao, et al., published as WO 03/044887 on May 30, 2003, incorporated herein by reference. The fuel delivery techniques taught by this reference may be modified to supply fuel to a porous separator, or directly to the anode. For example, in the embodiment illustrated in FIG. 1, fuel 14 is exposed directly to outer container 16, which may be a porous separator, as discussed herein.

The following documents are each incorporated herein by reference: International Patent Application No. PCT/US99/04741, filed Mar. 3, 1999, entitled “A Carbon-Oxygen Electricity-Generating Unit,” by T. Tao, et al., published as WO 99/45607 on Sep. 10, 1999; International Patent Application No. PCT/US01/12616, filed Apr. 18, 2001, entitled “An Electrochemical Device and Methods for Energy Conversion,” by T. Tao, et al., published as WO 01/80335 on Oct. 25, 2001; U.S. patent application Ser. No. 09/819,886, filed Mar. 28, 2001, entitled “A Carbon-Oxygen Fuel Cell,” by T. Tao, published as U.S. Patent Application Publication No. 2002/0015877 on Feb. 7, 2002, now U.S. Pat. No. 6,692,861, issued Feb. 17, 2004; International Patent Application No. PCT/US02/37290, filed Nov. 20, 2002, entitled “An Electrochemical System and Methods for Control Thereof,” by T. Tao, et al., published as WO 03/044887 on May 30, 2003; International Patent Application No. PCT/US03/03642, filed Feb. 6, 2003, entitled “Current Collectors,” by T. Tao, et al., published as WO 03/067683 on Aug. 14, 2003; and International Patent Application No. PCT/US02/20099, filed Jun. 25, 2002, entitled “Electrode Layer Arrangements in an Electrochemical Device,” by T. Tao, et al., published as WO 03/001617 on Jan. 3, 2003.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A cathode assembly for an electrochemical device, comprising:
a current collector comprising a core comprising a metal and a ceramic shell surrounding at least a portion of the core; and
a cathode in electrical contact with the current collector,
wherein the current collector and cathode are constructed to define one or more channels for flow of an oxidant gas through the cathode assembly, and
wherein the cathode contacts the current collector via one or more projections integrally formed with the cathode.

2. The cathode assembly of claim 1, wherein the current collector and the cathode are constructed to define an even number of channels.

3. The cathode assembly of claim 1, wherein the current collector and the cathode are constructed to define an odd number of channels.

4. The cathode assembly of claim 1, wherein the shell comprises a lanthanum-strontium-chromium oxide.

5. The cathode assembly of claim 1, wherein the shell comprises a lanthanum-calcium-chromium oxide.

6. The cathode assembly of claim 1, wherein the core comprises copper.

7. The cathode assembly of claim 1, wherein the core comprises nickel.

8. The cathode assembly of claim 1, wherein the core comprises silver.

9. The cathode assembly of claim 1, wherein the cathode comprises a ceramic.

10. The cathode assembly of claim 1, wherein the cathode comprises a lanthanum-calcium-manganese oxide.

11. The cathode assembly of claim 1, wherein the cathode comprises a lanthanum-strontium-manganese oxide.

12. The cathode assembly of claim 1, wherein the current collector is substantially cylindrical.

13. The cathode assembly of claim 1, wherein the cathode is substantially cylindrical.

14. The cathode assembly of claim 1, wherein the projections define one or more walls of at least one of the one or more of channels.

15. The cathode assembly of claim 1, wherein the one or more projections are integrally formed with the cathode.

16. A cathode assembly for an electrochemical device, comprising:
a current collector; and
a cathode in electrical contact with the current collector,
wherein the current collector and cathode are constructed to define one or more channels for flow of a gas.

17. The cathode assembly of claim 16, wherein the current collector and the cathode are constructed to define an even number of channels.

18. The cathode assembly of claim 16, wherein the current collector comprises:
a core comprising a metal, and
a shell, comprising a ceramic, surrounding at least a portion of the core.

19. The cathode assembly of claim 16, wherein the cathode contacts the current collector via one or more projections.

20. The cathode assembly of claim 16, wherein the electrochemical device is a fuel cell.

21. A cathode assembly for an electrochemical device, comprising:
a current collector; and
a cathode in electrical contact with the current collector,
wherein the cathode contacts the current collector via one or more projections such that the cathode and the current collector are not in intimate contact.

22-23. (canceled)
